(19) United States
(12) Patent Application Publication
(10) Pub. No.: US 2026/0072644 A1
(43) Pub. Date: Mar. 12, 2026

(54) FLOATING POINT OPERATIONS FOR A NEURAL NETWORK

(71) Applicant: APPLE INC., Cupertino, CA (US)

(72) Inventor: Christopher L. MILLS, Saratoga, CA (US)

(73) Assignee: APPLE INC., Cupertino, CA (US)

(21) Appl. No.: 18/827,344

(22) Filed: Sep. 6, 2024

(51) Int. Cl. G06F 7/544; G06F 5/01; G06F 7/485; G06F 7/487

(52) U.S. Cl. CPC G06F 7/5443; G06F 5/012; G06F 7/485; G06F 7/4876

(57) ABSTRACT

Disclosed herein are systems and methods for performing floating point (FP) operations in a NN. For example, a MAD circuit includes two data paths. Each of the data paths is configured to receive the same input data and multiply the same input data by different kernel coefficients to generate respective FP values. Each data path shifts its respective FP value to generate a respective shifted value that is aligned with a fixed point precision of an accumulator. One data path obtains data from a first set of register files of the accumulator, aggregates the data with its shifted value, and stores the resulting value in the first set of register files. The other data path obtains data from a second set of register files, aggregates the data with its shifted value, and stores the resulting value in the second set of register files.

### BACKGROUND

An artificial neural network (ANN) is a computing system or model that uses a collection of connected nodes (or “neurons”) to process input data. The ANN can be organized into layers where different layers perform different types of transformations on their input. Extensions or variants of ANN include convolution neural networks (CNNs), recurrent neural networks (RNNs), and deep belief networks (DBNs). Such neural networks involve extensive computing operations including multiplication and accumulation. For example, CNNs are a class of machine learning that can use convolution between input data and kernel data. The convolution can be decomposed into multiplication and accumulation operations.

ANNs may be utilized to implement various computation models, such as a large language model (LLM). LLMs are designed to mimic human language processing capabilities, including language understanding and generation. LLMs are widely used for natural language processing (NLP) tasks, such as text classification, question answering, and language translation. The training and inference of these models require a significant amount of computing power and energy consumption.

### SUMMARY

Various embodiments for performing floating point operations in a neural network are disclosed. In some embodiments, a method includes multiplying, by a multiply-add (MAD) circuit of a multiply-accumulate (MAC) circuit, a portion of input data and a portion of a first kernel coefficient of a neural network to generate a first floating point value. The method also includes shifting, by the MAD circuit, the first floating point value based on a first shift factor to generate a first shifted value that is aligned with a fixed point precision of a first accumulated value. The method further includes adding, by the MAD circuit, the first shifted value to the first accumulated value to generate a first output value. The method also includes storing the first output value in a first set of register files of the MAC circuit. The method further includes multiplying, by the multiply-add (MAD) circuit, the portion of the input data and a portion of a second kernel coefficient of the neural network to generate a second floating point value, where the second kernel coefficient is different from the first kernel coefficient. The method also includes shifting, by the MAD circuit, the second floating point value based on a second shift factor to generate a second shifted value that is aligned with a fixed point precision of a second accumulated value. The method further includes adding, by the MAD circuit, the second shifted value to the second accumulated value to generate a second output value. The method also includes storing the second output value in a second set of register files of the MAC circuit.

In some embodiments, a system includes a neural engine circuit. The neural engine circuit is configured to execute a neural network. The neural engine circuit includes a first multiplier circuit configured to multiply a portion of input data and a portion of a first kernel coefficient of the neural network to generate a first floating point value. The neural engine circuit also includes a first shift register circuit configured to shift the first floating point value based on a first shift factor to generate a first shifted value that is aligned with a fixed point precision of a first accumulated value. The neural engine circuit further includes a first adder circuit configured to add the first shifted value to the first accumulated value to generate a first output value. The neural engine circuit also includes a first set of register files configured to store the first output value. The neural engine circuit further includes a second multiplier circuit configured to multiply the portion of the input data and a portion of a second kernel coefficient of the neural network to generate a second floating point value, where the second kernel coefficient is different from the first kernel coefficient. The neural engine circuit also includes a second shift register circuit configured to shift the second floating point value based on a second shift factor to generate a second shifted value that is aligned with a fixed point precision of a second accumulated value. The neural engine circuit further includes a second adder circuit configured to add the second shifted value to the second accumulated value to generate a second output value. The neural engine circuit also includes a second set of register files configured to store the second output value in a second set of register files of the MAC circuit.

In some embodiments, a non-transitory computer readable medium having instructions stored thereon that, when executed by at least one processor, cause the at least one processor to perform operations. The operations include multiplying, by a MAD circuit of a MAC circuit, a portion of input data and a portion of a first kernel coefficient of a neural network to generate a first floating point value. The operations also include shifting, by the MAD circuit, the first floating point value based on a first shift factor to generate a first shifted value that is aligned with a fixed point precision of a first accumulated value. The operations further include adding, by the MAD circuit, the first shifted value to the first accumulated value to generate a first output value. The operations also include storing the first output value in one of a first set of register files of the MAC circuit. The operations further include multiplying, by the multiply-add (MAD) circuit, the portion of the input data and a portion of a second kernel coefficient of the neural network to generate a second floating point value, where the second kernel coefficient is different from the first kernel coefficient. The operations also include shifting, by the MAD circuit, the second floating point value based on a second shift factor to generate a second shifted value that is aligned with a fixed point precision of a second accumulated value. The operations further include adding, by the MAD circuit, the second shifted value to the second accumulated value to generate a second output value. The operations also include storing the second output value in one of a second set of register files of the MAC circuit that is different than the first set of register files.

### BRIEF DESCRIPTION OF THE DRAWINGS

The accompanying drawings are incorporated herein and form a part of the specification.

FIG. 1 is a high-level diagram of an electronic device, according to some embodiments.

FIG. 2 is a block diagram illustrating components in the electronic device, according to some embodiments.

FIG. 3 is a block diagram illustrating a neural processor, according to some embodiments.

FIG. 4 is a block diagram of a neural engine of the neural processor, according to some embodiments.

FIG. 5 is a block diagram of a multiply-accumulator circuit that is configured to perform floating point operations, according to some embodiments.

FIG. 6 is a flowchart for a method for performing floating point operations, according to some embodiments.

FIG. 7 is a flowchart for a method for generating a first shift factor and a second shift factor, according to some embodiments.

FIG. 8 is a flowchart for a method for obtaining a first accumulated value and a second accumulated value, according to some embodiments.

FIG. 9 is an example computer system that can be used for implementing some aspects or portion(s) thereof.

In the drawings, like reference numbers generally indicate identical or similar elements. Additionally, generally, the left-most digit(s) of a reference number identifies the drawing in which the reference number first appears.

### DETAILED DESCRIPTION

A neural network may be utilized to implement various computation models, including an LLM. Execution of an LLM involves compute intensive tasks, such as floating point-based multiplication operations. Such operations and functions consume many processing cycles, memory, and power. The embodiments described herein enable LLM parameters (e.g., activations) to be quantized utilizing an 8-bit floating point (FP8) format. Due to its higher dynamic range (e.g., as compared to an 8-bit integer (INT8) format), more LLM parameters may be quantized, thereby making LLM interference faster and more efficient. As such, the number of processing cycles, as well as the bandwidth, power, and memory to execute the LLM are reduced. Moreover, two data paths may be utilized concurrently in parallel to generate two floating point-based results in a given processing cycle, thereby doubling the throughput for floating point operations.

For instance, provided herein are a system, apparatus, device, method and/or computer program product embodiments, and/or combinations and sub-combinations thereof, for performing floating point operations in a neural network. For example, a multiply-add (MAD) circuit of a multiply-accumulate (MAC) circuit may include two data paths for generating output values based on floating point operations. Each of the first data path and the second data path may be configured to receive the same input data and multiply the same input data by different kernel coefficients to generate respective floating point values. Each of the data paths may shift its respective floating point value to generate a respective shifted value that is aligned with a fixed point precision of an accumulator used to store and aggregate data. The first data path may obtain data from a first set of register files of the accumulator, aggregate the data with its shifted value, and store the resulting value in the first set of register files. The second data path may obtain data from a second set of register files of the accumulator, aggregate the data with its shifted value, and store the resulting value in the second set of register files.

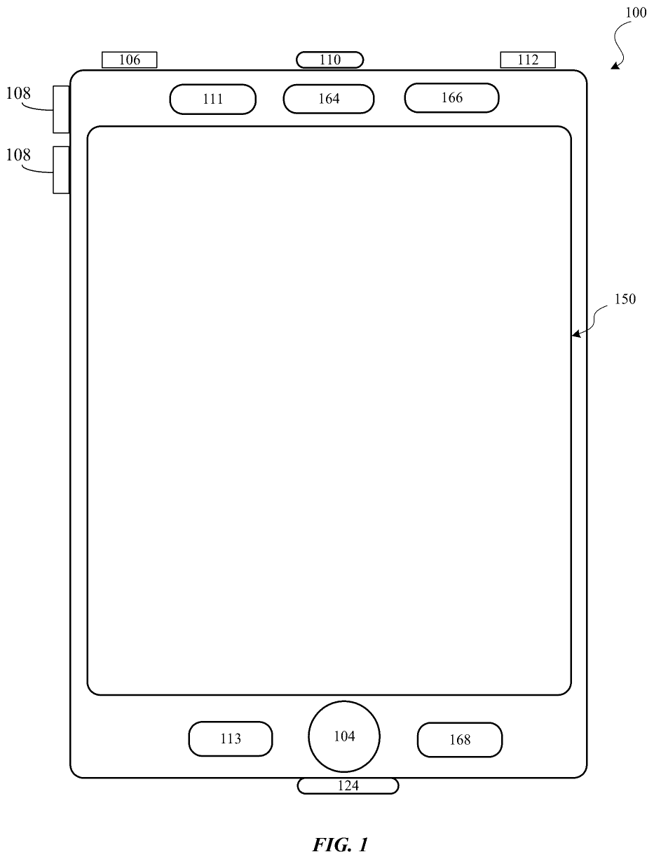

Embodiments of electronic devices, user interfaces for such devices, and associated processes for using such devices are described. In some embodiments, the device is a portable communications device, such as a mobile telephone, that also contains other functions, such as personal digital assistant (PDA) and/or music player functions. Exemplary embodiments of portable multifunction devices include, without limitation, the iPhone®, iPod Touch®, Apple Watch®, and iPad® devices from Apple Inc. of Cupertino, California. Other portable electronic devices, such as wearables, laptops or tablet computers, are optionally used. In some embodiments, the device is not a portable communication device, but is a desktop computer or other computing device that is not designed for portable use. In some embodiments, the disclosed electronic device may include a touch-sensitive surface (e.g., a touch screen display and/or a touchpad). An example electronic device described below in conjunction with FIG. 1 (e.g., device 100) may include a touch-sensitive surface for receiving user input. The electronic device may also include one or more other physical user-interface devices, such as a physical keyboard, a mouse and/or a joystick.

FIG. 1 is a high-level diagram of an electronic device 100, according to some embodiments. Device 100 may include one or more physical buttons, such as a “home” or menu button 104. Menu button 104 is, for example, used to navigate to any application in a set of applications that are executed on device 100. In some embodiments, menu button 104 includes a fingerprint sensor that identifies a fingerprint on menu button 104. The fingerprint sensor may be used to determine whether a finger on menu button 104 has a fingerprint that matches a fingerprint stored for unlocking device 100. Alternatively, in some embodiments, menu button 104 is implemented as a soft key in a graphical user interface (GUI) displayed on a touch screen.

In some embodiments, device 100 includes touch screen 150, menu button 104, push button 106 for powering the device on/off and locking the device, volume adjustment buttons 108, Subscriber Identity Module (SIM) card slot 110, headset jack 112, and docking/charging external port 124. Push button 106 may be used to turn the power on/off on device 100 by depressing button 106 and holding button 106 in the depressed state for a predefined time interval; to lock the device by depressing button 106 and releasing button 106 before the predefined time interval has elapsed; and/or to unlock device 100 or initiate an unlock process. Alternatively, in some embodiments, device 100 also accepts verbal input for activation or deactivation of some functions through microphone 113. Device 100 includes various components including a memory (which may include one or more computer readable storage mediums), a memory controller, one or more central processing units (CPUs), a peripherals interface, an RF circuitry, an audio circuitry, speaker 111, microphone 113, an input/output (I/O) subsystem, and other input or control devices. Device 100 may include one or more image sensors 164, one or more proximity sensors 166, and one or more accelerometers 168. Device 100 may include more than one type of image sensors 164. Each type may include more than one image sensor 164. For example, one type of image sensors 164 may be cameras and another type of image sensors 164 may be infrared sensors for facial recognition that is performed by one or more machine learning models stored in device 100. Device 100 may include components not shown in FIG. 1, such as an ambient light sensor, a dot projector and a flood illuminator that is to support facial recognition.

Device 100 is only one example of an electronic device, and device 100 may have more or fewer components than listed above, some of which may be combined into a component or have a different configuration or arrangement. In some embodiments, device 100 does not have audio/visual components, such as touch screen 150, speaker 111, or image sensors 164. The various components of device 100 listed above are embodied in hardware, software, firmware, or a combination thereof, including one or more signal processing and/or application-specific integrated circuits (ASICs).

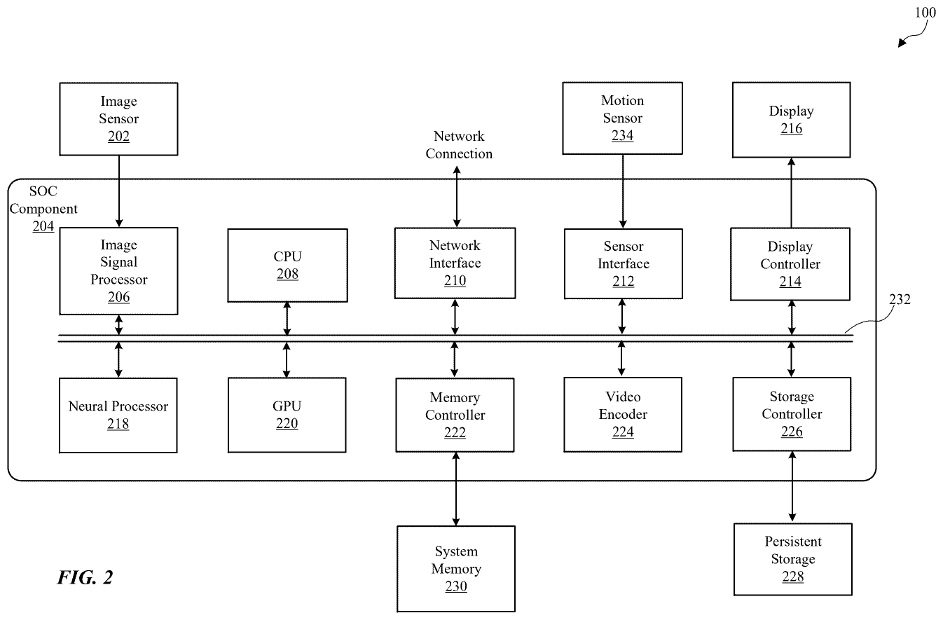

FIG. 2 is a block diagram illustrating components in device 100, according to some embodiments. Device 100 may perform various operations including implementing one or more machine learning models. For this and other purposes, device 100 may include, among other components, image sensors 202, a system-on-a-chip (SOC) component 204, a system memory 230, a persistent storage (e.g., flash memory) 228, a motion sensor 234, and a display 216. The components as illustrated in FIG. 2 are merely illustrative. For example, device 100 may include other components (such as a speaker or a microphone) that are not illustrated in FIG. 2. Further, some components (such as motion sensor 234) may be omitted from device 100.

An image sensor 202 is a component for capturing image data and may include, for example, a complementary metal-oxide-semiconductor (CMOS) active-pixel sensor, a camera, video camera, or other devices. Image sensor 202 generates raw image data that is sent to SOC component 204 for further processing. In some embodiments, the image data processed by SOC component 204 is displayed on display 216, stored in system memory 230, persistent storage 228 or sent to a remote computing device via network connection. The raw image data generated by image sensor 202 may be in a Bayer color filter array (CFA) pattern. It is noted that the raw image data may be in other formats or patterns.

Motion sensor 234 is a component or a set of components for sensing motion of device 100. Motion sensor 234 may generate sensor signals indicative of orientation and/or acceleration of device 100. The sensor signals are sent to SOC component 204 for various operations, such as turning on device 100 or rotating images displayed on display 216.

Display 216 is a component for displaying images as generated by SOC component 204. Display 216 may include, for example, a liquid crystal display (LCD) device or an organic light-emitting diode (OLED) device. Based on data received from SOC component 204, display 116 may display various images, such as menus, selected operating parameters, images captured by image sensor 202 and processed by SOC component 204, and/or other information received from a user interface of device 100 (not shown).

System memory 230 is a component for storing instructions for execution by SOC component 204 and for storing data processed by SOC component 204. System memory 230 may include any type of memory including, for example, dynamic random access memory (DRAM), synchronous DRAM (SDRAM), double data rate (DDR, DDR2, DDR3, etc.) RAMBUS DRAM (RDRAM), static RAM (SRAM), or a combination thereof.

Persistent storage 228 is a component for storing data in a non-volatile manner. Persistent storage 228 retains data even when power is not available. Persistent storage 228 may include read-only memory (ROM), flash memory or other non-volatile random access memory devices. Persistent storage 228 stores an operating system of device 100 and various software applications. Persistent storage 228 may also store one or more machine learning models, such as regression models, random forest models, support vector machines (SVMs) such as kernel SVMs, and artificial neural networks (ANNs) (e.g., convolutional network networks (CNNs), recurrent network networks (RNNs), autoencoders, and long short term memory (LSTM)-based neural networks). A machine learning model may be an independent model that works with a neural processor 218 and various software applications or sensors of device 100. A machine learning model may also be part of a software application. The machine learning models may perform various tasks, such as facial recognition, image classification, video classification, object, concept and information classification, speech recognition, machine translation, voice recognition, voice command recognition, text recognition, text and context analysis, other natural language processing, predictions, and recommendations.

Various machine learning models stored in device 100 may be fully trained, untrained, or partially trained to allow device 100 to reinforce or continue to train the machine learning models as device 100 is used. Operations of the machine learning models include various computation used in training the models and determining results during runtime using the models. For example, device 100 captures facial images of the user and uses the images to continue to improve a machine learning model that is used to lock or unlock the device 100.

SOC component 204 may include one or more integrated circuit (IC) chips and performs various data processing processes. SOC component 204 may include, among other subcomponents, image signal processor (ISP) 206, a central processor unit (CPU) 208, a network interface 210, sensor interface 212, display controller 214, neural processor 218, graphics processor (GPU) 220, memory controller 222, video encoder 224, storage controller 226, and bus 232 connecting these subcomponents. SOC component 204 may include more or fewer subcomponents than those shown in FIG. 2.

ISP 206 may be implemented by processing logic that can include hardware (e.g., circuitry, dedicated logic, programmable logic, or microcode), software (e.g., instructions executing on a processing device), or a combination thereof. ISP 206 may perform various stages of an image processing pipeline. In some embodiments, ISP 206 may receive raw image data from image sensor 202, and process the raw image data into a form that is usable by other subcomponents of SOC component 204 or components of device 100. ISP 206 may perform various image-manipulation operations, such as image translation operations, horizontal and vertical scaling, color space conversion and/or image stabilization transformations.

CPU 208 may include any suitable instruction set architecture, and may be configured to execute instructions defined in that instruction set architecture. CPU 208 may be general-purpose or embedded processors using any of a variety of instruction set architectures (ISAs), such as the x86, PowerPC, SPARC, RISC, ARM or MIPS ISAs, or any other suitable ISA. Although a single CPU is illustrated in FIG. 2, SOC component 204 may include multiple CPUs. In multiprocessor systems, each of the CPUs may implement the same ISA.

Graphics processing unit (GPU) 220 may include graphics processing circuitry for performing various operations, including graphics and video rendering. For example, GPU 220 may render objects to be displayed into a frame buffer (e.g., one that includes pixel data for an entire frame). GPU 220 may include one or more graphics processors that may execute graphics software to perform a part or all of the graphics operation, or hardware acceleration of certain graphics operations.

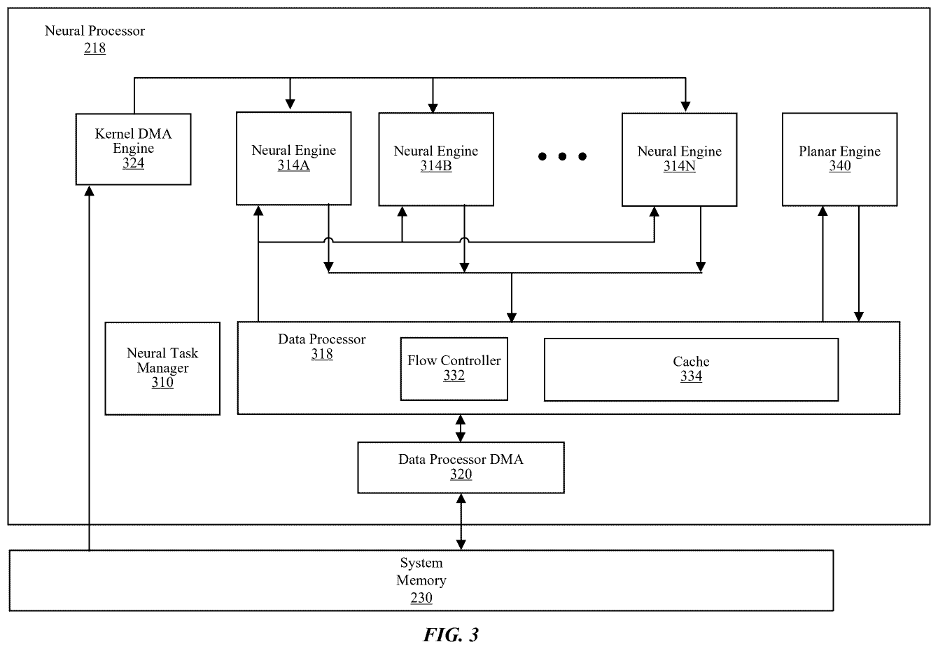

Neural processor 218 may be implemented by processing logic that can include hardware (e.g., circuitry, dedicated logic, programmable logic, or microcode), software (e.g., instructions executing on a processing device), or a combination thereof. Neural processor 218 may perform various machine learning operations based on computation including multiplication, addition, and accumulation. Such computation may be arranged to perform, for example, various types of tensor multiplications, such as tensor product and convolution of input data and kernel data (e.g., weights). Neural processor 218 may be configurable and may perform these operations in a fast and power-efficient manner while relieving CPU 208 of resource-intensive operations associated with neural network operations. Neural processor 218 may receive the input data from sensor interface 212, image signal processor 206, persistent storage 228, system memory 230 or other sources (e.g., network interface 210 or GPU 220). The output of neural processor 218 may be provided to various components of device 100, such as image signal processor 206, system memory 230 or CPU 208 for various operations. In some embodiments, neural processor 218 is implemented as a standalone processing unit on a device, such as device 100. In some embodiments, neural processor 218 is one multiple neural processors 218 connected by bus 232. The structure and operation of neural processor 218 are described below in detail with reference to FIG. 3.

Network interface 210 is a subcomponent that enables data to be exchanged between devices 100 and other devices via one or more networks (e.g., carrier or agent devices). For example, audio, video, or other image data may be received from other devices via network interface 210 and be stored in system memory 230 for subsequent processing (e.g., via a back-end interface to image signal processor 206) and display. The networks may include Local Area Networks (LANs) (e.g., an Ethernet or corporate network) and Wide Area Networks (WANs). The image data received via network interface 210 may undergo image processing processes by ISP 206.

Sensor interface 212 may be implemented by processing logic that can include hardware (e.g., circuitry, dedicated logic, programmable logic, or microcode), software (e.g., instructions executing on a processing device), or a combination thereof. Sensor interface 212 interfaces with motion sensor 234. Sensor interface 212 receives sensor information from motion sensor 234 and processes the sensor information to determine the orientation or movement of device 100.

Display controller 214 may be implemented by processing logic that can include hardware (e.g., circuitry, dedicated logic, programmable logic, or microcode), software (e.g., instructions executing on a processing device), or a combination thereof. Display controller 214 may provide video or image data to display 216 for display thereby. Display controller 214 may receive the video or image data from ISP 206, CPU 208, GPU 220, or system memory 230 and may process the video or image data into a format suitable for display on display 216.

Memory controller 222 may be implemented by processing logic that can include hardware (e.g., circuitry, dedicated logic, programmable logic, or microcode), software (e.g., instructions executing on a processing device), or a combination thereof. Memory controller 222 may communicate with system memory 230. Memory controller 222 may read data from system memory 230 for processing by ISP 206, CPU 208, GPU 220 or other subcomponents of SOC component 204. Memory controller 222 may also write data to system memory 230 received from various subcomponents of SOC component 204.

Video encoder 224 may be implemented by processing logic that can include hardware (e.g., circuitry, dedicated logic, programmable logic, or microcode), software (e.g., instructions executing on a processing device), or a combination thereof. Video encoder 223 may encode video data into a format suitable for storing in persistent storage 228 or for passing the data to network interface 210 for transmission over a network to another device.

In some embodiments, one or more subcomponents of SOC component 204 or some functionality of these subcomponents may be performed by software components executed on neural processor 218, ISP 206, CPU 208 or GPU 220. Such software components may be stored in system memory 230, persistent storage 228 or another device communicating with device 100 via network interface 210.

Neural processor 218 may be configured to perform machine learning operations on the input data of neural processor 218. Machine learning operations may include different computations for training of a machine learning model and for performing inference or prediction based on the trained machine learning model.

Taking an example of a CNN as the machine learning model, training of the CNN may include forward propagation and backpropagation. A neural network may include an input layer, an output layer, and one or more intermediate layers that may be referred to as “hidden layers.” Each layer may include one or more nodes (or neurons), which may be fully or partially connected to other nodes in adjacent layers. During forward propagation, the neural network performs computation in the forward direction based on outputs of a preceding layer. The operation of a node may be defined by one or more functions. The functions that define the operation of a node may include various computation operations, such as convolution of data with one or more kernels, pooling of layers, tensor multiplication, etc. The functions may also include an activation function that adjusts the weight of the output of the node. Nodes in different layers may be associated with different functions. For example, a CNN may include one or more convolutional layers that are mixed with pooling layers and are followed by one or more fully connected layers.

Each of the functions, including kernels, in a machine learning model may be associated with different coefficients that are adjustable during training. In addition, some of the nodes in a neural network each may also be associated with an activation function that decides the weight of the output of the node in a forward propagation. Common activation functions may include step functions, linear functions, sigmoid functions, hyperbolic tangent functions (tanh), and rectified linear unit (ReLU) functions. After a batch of data of training samples passes through a neural network in the forward propagation, the results may be compared to the training labels of the training samples to compute the network's loss function, which represents the performance of the network. In turn, the neural network performs backpropagation by using coordinate descent, such as stochastic coordinate descent (SGD), to adjust the coefficients in various functions to improve the value of the loss function.

During training, device 100 may use neural processor 218 to perform all or some of the operations in the forward propagation and backpropagation. Multiple rounds of forward propagation and backpropagation may be performed by neural processor 218, solely or in coordination with other processors, such as CPU 208, GPU 220, and ISP 206. Training may be completed when the loss function no longer improves (e.g., the machine learning model has converged) or after a predetermined number of rounds for a particular set of training samples. As device 100 is used, device 100 may continue to collect additional training samples for the neural network.

During prediction or inference, device 100 may receive one or more input samples. Neural processor 218 may take the input samples to perform forward propagation to determine one or more results. The input samples may be images, speeches, text files, sensor data, video data, audio data, or other data.

Data and functions (e.g., input data, kernels, functions, layer outputs, gradient data, etc.) in machine learning may be saved and represented by one or more tensors. Common operations related to training and runtime of a machine learning model may include tensor product, tensor transpose, tensor elementwise operation, convolution, application of an activation function, automatic differentiation to determine gradient, statistics and aggregation of values in tensors (e.g., average, variance, standard deviation), tensor rank and size manipulation, etc.

While the training and runtime of a neural network is discussed as an example, the neural processor 218 may also be used for the operations of other types of machine learning models, such as a kernel support vector machine (SVM) model.

Referring to FIG. 3, an example neural processor 218 may include, among other components, a neural task manager 310, neural network engines 314A through 314N (hereinafter collectively referred as “neural engines 314” and individually also referred to as “neural engine 314”), a kernel direct memory access (DMA) engine 324, a data processor 318, a data processor DMA engine 320, and a planar engine 340. Neural processor 218 may include fewer or additional components not illustrated in FIG. 3.

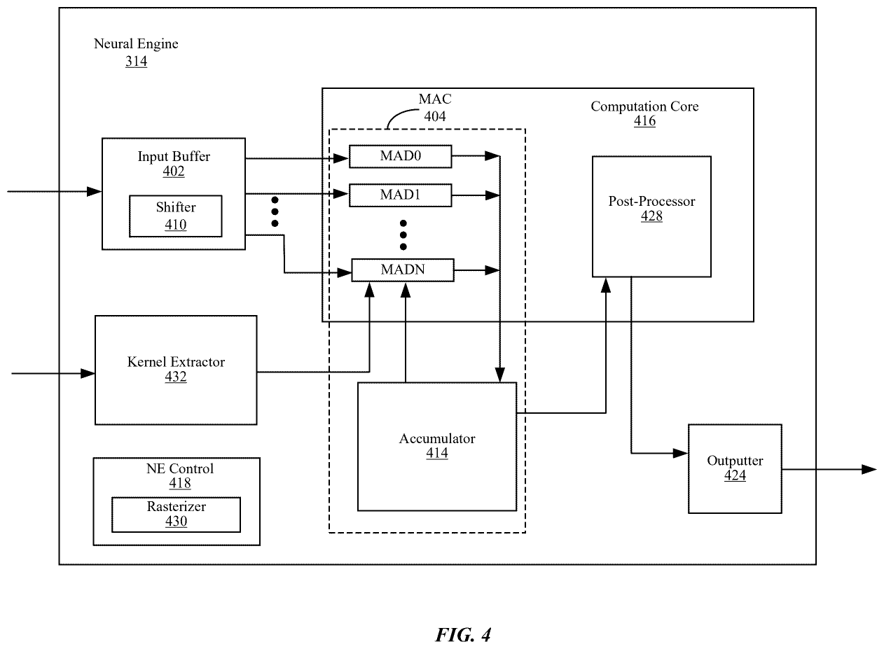

Each of neural engines 314 performs computing operations for machine learning in parallel. Depending on the load of operation, the entire set of neural engines 314 may be operating or only a subset of neural engines 314 may be operating while the remaining neural engines 314 are placed in a power-saving mode to conserve power. Each of neural engines 314 includes components for storing one or more kernels, for performing multiply-accumulate operations, activation functions, and for post-processing to generate output data, as described below in detail with reference to FIG. 4. Neural engines 314 may specialize in performing computationally heavy operations, such as matrix multiplication operations, convolution operations, and tensor product operations. Convolution operations may include different kinds of convolutions, such as cross-channel convolutions (e.g., a convolution that accumulates values from different channels), channel-wise convolutions, and transposed convolutions.

Planar engine 340 may specialize in performing simpler computing operations, where speed may primarily depend on the input and output (I/O) speed of the data transmission instead of the computation speed within planar engine 340. Those computing operations may be referred to as “I/O bound computations.” In contrast, neural engines 314 may focus on complex computations, where speed may primarily depend on the computation speed within each neural engine 314. For example, planar engine 340 is efficient at performing operations within a single channel while neural engines 314 are efficient at performing operations across multiple channels that may involve heavy accumulation of data. The use of neural engine 314 to compute I/O bound computations may not be efficient in terms of both speed and power consumption. In some embodiments, input data may be a tensor whose rank is larger than three (e.g., having three or more dimensions). A set of dimensions (two or more) in the tensor may be referred to as a “plane,” while another dimension may be referred to as a “channel.” Neural engines 314 may convolve data of a plane in the tensor with a kernel and accumulate results of the convolution of different planes across different channels. On the other hand, planar engine 340 may specialize in operations within the plane.

Planar engine 340 may be programmed for operation in one of multiple modes, including a pooling mode, an elementwise mode, and a reduction mode. In the pooling mode, planar engine 340 reduces a spatial size of input data. In the elementwise mode, planar engine 340 generates an output that is derived from elementwise operations of one or more inputs. In the reduction mode, planar engine 340 reduces the rank of a tensor. For example, a rank 5 tensor may be reduced to a rank 2 tensor, or a rank 3 tensor may be reduced to a rank 0 tensor (e.g., a scalar).

Neural task manager 310 manages the overall operation of neural processor 218. Neural task manager 310 may receive a task list from a compiler executed by CPU 208, store tasks in its task queues, choose a task to perform, and send task commands to other components of neural processor 218 for performing the chosen task. Data may be associated with a task command that indicates the types of operations to be performed on the data. Data of neural processor 218 includes input data that is transmitted from another source, such as system memory 230, and data generated by neural processor 218 in a previous operation cycle. Each dataset may be associated with a task command that specifies the type of operations to be performed on the data. Neural task manager 310 may also perform switching of tasks on detection of events, such as receiving instructions from CPU 208. In some embodiments, neural task manager 310 sends rasterizer information to the components of neural processor 218 to enable each of the components to track, retrieve, or process appropriate segments of the input data and kernel data. For example, neural task manager 310 may include registers that stores the information regarding the size and rank of a dataset for processing by neural processor 218.

For instance, input data may be split into smaller pieces of data for parallel processing at multiple neural engines 314 and planar engine 340. In some embodiments, a set of data used for a convolution operation may be a subset of data from a token. A set of data used for a convolution operation may be referred to as a “convolution group,” which can be split into multiple smaller units. The hierarchy of smaller units (segments) may be convolution groups, slices, tiles, work units (WUs), output channel groups, input channels (Cin), sub-Cins for input stride, etc. For example, a convolution group may be split into several slices; a slice may be split into several tiles; a tile may be split into several work units; and so forth. In the context of neural engine 314, a work unit may be a segment of the input data, such as data processed by planar engine 340 or data processed in a prior cycle of neural engines 314, having a size suitable for an accumulator (e.g., accumulator 414, as shown in FIG. 4) of neural engines 314. In one case, the size of each work unit is 256 bytes. In some embodiments, work units can be shaped to one of 16×16, 32×8, 64×4, 128×2 or 256×1 datasets.

In an example in which an image is input to neural engines 314, the image may be represented as a multi-dimensional matrix, where each dimension includes one or more segments (e.g., work units) of the input data. In an example, a first dimension corresponds to the width (w) of the image, a second dimension corresponds to the height (h) of the image, and a third dimension corresponds to a depth or color channel (c) of the image (e.g., a red channel, a blue channel, or a green channel for a red, green, blue (RGB) image). It is noted that this is merely one example of a channel and that input data can have any number of channels depending on the features extracted from the input data.

In the context of planar engine 340, a work unit may be (i) a segment of input data, (ii) data from neural engine 314, or (iii) data from a prior cycle of planar engine 340 that can be processed simultaneously at planar engine 340. Although neural task manager 310 is illustrated in FIG. 3 as part of neural processor 218, neural task manager 310 may be a component outside neural processor 218.

Kernel DMA engine 324 may be implemented by processing logic that can include hardware (e.g., circuitry, dedicated logic, programmable logic, or microcode), software (e.g., instructions executing on a processing device), or a combination thereof. Kernel DMA engine 324 may be configured to fetch kernel data (e.g., kernel coefficients) from a source (e.g., system memory 230) and sends kernel coefficients to each of neural engines 314. The kernel coefficients may be stored in a kernel matrix, which is stored in a portion of system memory 230 that is allocated and configured to store the kernel matrix. Kernel data represents information from which kernel elements can be extracted. In some embodiments, the kernel data may be in a compressed format, which is decompressed at each of neural engines 314. Although kernel data provided to each of neural engines 314 may be the same in some instances, the kernel data provided to each of neural engines 314 is different in most instances. In some embodiments, the direct memory access nature of kernel DMA engine 324 may allow kernel DMA engine 324 to fetch and write data directly from the source without the involvement of CPU 208.

Data processor 318 may be implemented by processing logic that can include hardware (e.g., circuitry, dedicated logic, programmable logic, or microcode), software (e.g., instructions executing on a processing device), or a combination thereof. Data processor 318 may be configured to manage data traffic and task performance of neural processor 218. Data processor 318 may include a flow controller 332 and a cache 334. Cache 334 is temporary storage for storing data associated with operations of neural processor 218 and planar engine 340, such as input data that is transmitted to and/or received from system memory 230 (e.g., data from a machine learning model) and other data that is generated within neural processor 218 or planar engine 340. The data stored in cache 334 may include different subsets that are sent to various downstream components, such as neural engines 314 and planar engine 340. In one example, cache 334 may be a level 2 (L2) cache.

In some embodiments, cache 334 includes a non-transitory memory that can be accessed by neural engines 314 and planar engine 340. Cache 334 may store input data for feeding to corresponding neural engines 314A through 314N or planar engine 340, as well as output data from each of neural engines 314A through 314N or planar engine 340 for feeding back into one or more neural engines 314 or planar engine 340, or sending to a target circuit (e.g., system memory 230). Cache 334 may also store input data and output data of planar engine 340 and allow the exchange of data between neural engine 314 and planar engine 340. For example, one or more the output data of neural engines 314 are used as input data to planar engine 340. Likewise, the output of planar engine 340 may be used as input data of neural engines 314. The inputs of neural engines 314 or planar engine 340 may be any data stored in cache 334. For example, in various operating cycles, the source datasets from one of the engines (e.g., neural engines 314 or planar engine 340) fetches as inputs may be different. The input of an engine may be an output of the same engine in previous cycles, outputs of different engines, or any other suitable source datasets stored in buffer memory 334. Also, a dataset in cache 334 may be divided and sent to different engines for different operations in the next operating cycle. Two datasets in cache 334 may also be joined for the next operation.

Flow controller 332 of data processor 318 may be implemented by processing logic that can include hardware (e.g., circuitry, dedicated logic, programmable logic, or microcode), software (e.g., instructions executing on a processing device), or a combination thereof. Flow controller 332 may be configured to control the exchange of data between neural engines 314 and planar engine 340. The operations of data processor 318 and other components of neural processor 218 are coordinated so that the input data and intermediate data stored in data processor 318 may be reused across multiple operations at neural engines 314 and planar engine 340, thereby reducing data transfer to and from system memory 230. Flow controller 332 may perform one or more of the following operations: (i) monitor the size and rank of data (e.g., data may be one or more tensors) that are being processed by neural engines 314 and planar engine 340, (ii) determine which subsets of data are transmitted to neural engines 314 or to planar engine 340 based on the task commands associated with different subsets of data, (iii) determine the manner in which data is transmitted to neural engines 314 and planar engine 340 (e.g., data processor 318 may operate in a broadcast mode where the same data is fed to multiple input channels of neural engines 314 so that multiple or all neural engines 314 receive the same data or in a unicast mode where different neural engines 314 receive different data), and (iv) transmit a configuration command to the planar engine 340 to direct planar engine 340 to program itself for operating in one of multiple operation modes.

The data of neural processor 218 stored in cache 334 may be part of, among others, image data, histogram of oriented gradients (HOG) data, audio data, metadata, output data of a previous cycle of a neural engine 314, and other processed data received from other components of the SOC component 204.

As described above, neural engines 314 may be configured to perform matrix multiplication operations, for example, when executing a large language model (LLM). Such operations may be performed as a multi-channel 1×1 convolution, where a 1×1 filter including a single weight for each channel. The filter may be applied to an input feature map with a stride of one (e.g., left-to-right and top-to-bottom) resulting in an output feature map (also referred to as an “activation map”) with the same width and height as the input. One or more activation functions may also be applied on the output feature map (e.g., step functions, linear functions, sigmoid functions, tanh functions, and/or ReLU functions).

Data processor DMA engine 320 may be implemented by processing logic that can include hardware (e.g., circuitry, dedicated logic, programmable logic, or microcode), software (e.g., instructions executing on a processing device), or a combination thereof. Data processor DMA engine 320 may be configured to receive at least a portion (e.g., a work unit or a tile) of the input data from a source (e.g., system memory 230) for storing in cache 334, and/or write at least a portion of data from cache 334 to a target (e.g., system memory 230).

FIG. 4 is a block diagram of neural engine 314, according to some embodiments. Neural engine 314 performs various operations to facilitate machine learning, such as convolution (e.g., matrix multiplication), tensor product, and other operations that may involve heavy computations. For this purpose, neural engine 314 receives the input data, performs multiply-accumulate operations (e.g., convolution operations) on the input data based on the stored kernel coefficients received from kernel DMA engine 324, performs further post-processing operations on the result of the multiply-accumulate operations, and generates output data. The input data obtained by neural engine 314 and/or the output data provided by neural engine 314 may be of a single channel or span across multiple channels.

Neural engine 314 may include, among other components, an input buffer 402, a computation core 416, a neural engine (NE) control 418, an accumulator 414, an outputter 424, and a kernel extractor 432. Neural engine 314 may include fewer components than what is illustrated in FIG. 4 or include further components not illustrated in FIG. 4.

Input buffer 402 may be implemented by processing logic that can include hardware (e.g., circuitry, dedicated logic, programmable logic, or microcode), software (e.g., instructions executing on a processing device), or a combination thereof. Input buffer 402 may store a subset of the input data of neural processor 218 as the subset of the input data is received from a source. The source may be data processor 318, planar engine 340, or another suitable component. Input buffer 402 may send an appropriate segment of input data for a current task or process loop to computation core 416 for processing. Input buffer 402 may include a shifter 410 that shifts read locations of input buffer 402 to change the segment of the input data sent to computation core 416. By changing segments of the input data provided to computation core 416 via shifting, neural engine 314 can perform multiply-accumulate for different segments of the input data based on a fewer number of read operations. In some embodiments, the input data of neural processor 218 includes data of difference convolution groups and/or input channels.

Kernel extractor 432 is a circuit that receives kernel data from kernel DMA engine 324 and extracts kernel coefficients. In some embodiments, kernel extract circuit 432 is a circuit that receives kernel data 326 from kernel DMA 324 and extracts kernel coefficients 422. In some embodiments, the kernel extract circuit 432 references a data structure (e.g., look up table (LUT)) and uses a mask to reconstruct a kernel from compressed kernel data. The mask indicates locations in the reconstructed kernel to be padded with zeroes and remaining locations to be filled with numbers. The kernel coefficients of the reconstructed kernel are sent to computation core 416 to populate registers in multiply-add (MAD) circuits of computation core 416. In some embodiments, kernel extractor 432 receives kernel data in an uncompressed format and the kernel coefficients are determined without referencing the data structure or using a mask. The determined kernel coefficients are provided to computation core 416, for example, to perform a convolution operation utilizing MAD circuits MAD0 through MADN.

Computation core 416 may be implemented by processing logic that can include hardware (e.g., circuitry, dedicated logic, programmable logic, or microcode), software (e.g., instructions executing on a processing device), or a combination thereof. Computation core 416 may be configured to perform computation operations. For this purpose, computation core 416 may include MAD circuits MAD0 through MADN and a post-processor 428. Each of MAD circuits MAD0 through MADN may store an input value in the segment of the input data and a corresponding kernel coefficient from the kernel coefficients received from kernel DMA engine 324. The input value and the corresponding kernel coefficient are multiplied in each of MAD circuits MAD0 through MADN to generate a processed value.

Accumulator 414 may be implemented by processing logic that can include hardware (e.g., circuitry, dedicated logic, programmable logic, or microcode), software (e.g., instructions executing on a processing device), or a combination thereof. Accumulator 414 may be configured to receive and store processed values from MAD circuits MAD0 through MADN. The processed values stored in accumulator 414 may be sent back as feedback information for further multiply and add operations at MAD circuits or sent to post-processor 428 for post-processing. Accumulator 414 in combination with MAD circuits form a multiply-accumulator (MAC) 404.

Post-processor 428 may be implemented by processing logic that can include hardware (e.g., circuitry, dedicated logic, programmable logic, or microcode), software (e.g., instructions executing on a processing device), or a combination thereof. Post-processor 428 may be configured to further process values received from accumulator 414. Post-processor 428 may perform operations including applying linear functions (e.g., Rectified Linear Unit (ReLU)), normalized cross-correlation (NCC), merging the results of performing neural operations on 8-bit data into 16-bit data, and local response normalization (LRN). The result of such operations is output from post-processor 428 as processed values to outputter 424. In some embodiments, the processing at the post-processor 428 is bypassed. For example, the data in accumulator 414 may be sent directly to outputter 424 for access by other components of neural processor 218.

NE control 418 may be implemented by processing logic that can include hardware (e.g., circuitry, dedicated logic, programmable logic, or microcode), software (e.g., instructions executing on a processing device), or a combination thereof. NE control 418 may be configured to control operations of other components of neural engine 314 based on the operation modes and parameters of neural processor 218. Depending on different modes of operation (e.g., group convolution mode or non-group convolution mode) or parameters (e.g., the number of input channels and the number of output channels), neural engine 314 may operate on different input data in different sequences, return different values from accumulator circuit 414 to MAD circuits, and perform different types of post-processing operations at post-processor 428. To configure components of neural engine 314 to operate in a desired manner, NE control 418 sends task commands that may be included in the feedback information to components of neural engine 314. NE control 418 may include a rasterizer 430 that tracks the current task or process loop being processed at neural engine 314.

Rasterizer 430 may be implemented by processing logic that can include hardware (e.g., circuitry, dedicated logic, programmable logic, or microcode), software (e.g., instructions executing on a processing device), or a combination thereof. Rasterizer 430 may be configured to perform the operations associated with dividing the input data into smaller units (segments) and regulate the processing of the smaller units through the MACs 404 and accumulator 414. Rasterizer 430 may keep track of sizes and ranks of segments of the input/output data (e.g., groups, work units, input channels, output channels) and instructs the components of neural processor 218 for proper handling of the segments of the input data. For example, rasterizer 430 operates shifters 410 in input buffer 402 to forward the correct segments 408 of input data to MAC 404 and send the finished output data to buffer cache 334. Other components of neural processor 218 (e.g., kernel DMA engine 324, cache 334, planar engine 340) may also have their corresponding rasterizers to monitor the division of input data and the parallel computation of various segments of input data in different components.

Outputter 424 may be implemented by processing logic that can include hardware (e.g., circuitry, dedicated logic, programmable logic, or microcode), software (e.g., instructions executing on a processing device), or a combination thereof. Outputter 424 may receive the processed values from post-processor 428 and interface with data processor 318 to store the processed values in data processor 318. For this purpose, outputter 424 may send output data in a sequence or a format that is different from the sequence or format in which the processed values are processed in post-processor 428.

The components in neural engine 314 may be configured during a configuration period by NE control 418 and neural task manager 310. For this purpose, neural task manager 310 sends configuration information to neural engine 314 during the configuration period. The configurable parameters and modes may include mapping between input data elements and kernel elements, the number of input channels, the number of output channels, performing of output strides, and enabling/selection of post-processing operations at post-processor 428.

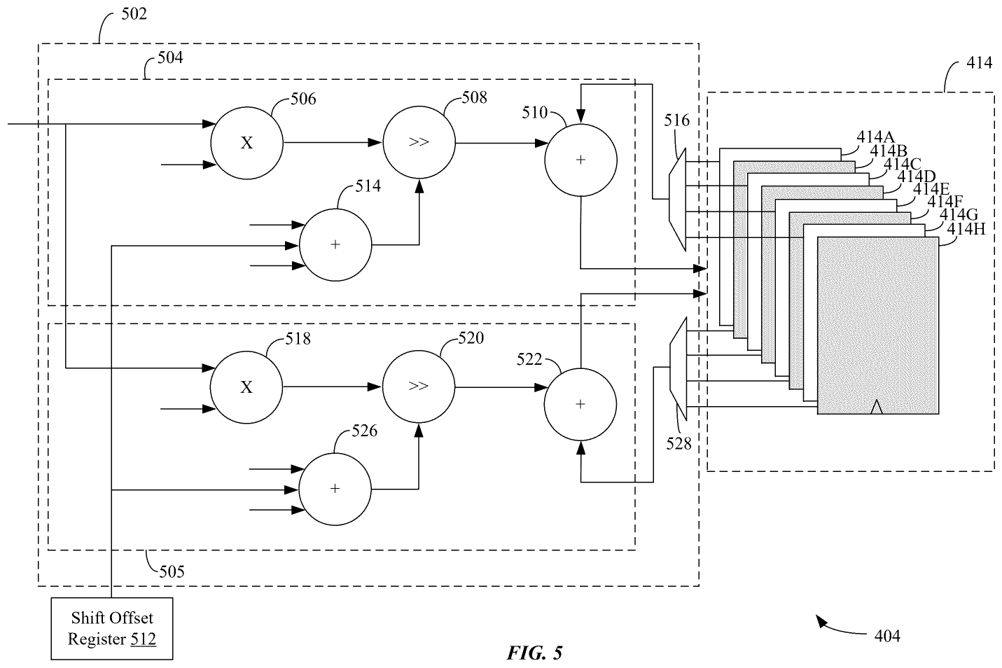

In some embodiments, each MAC 404 may be configured to perform floating point operations (e.g., floating point convolutions). For example, FIG. 5 is a block diagram of an example MAC 404 that is configured to perform floating point operations, according to some embodiments. As shown in FIG. 5, MAC 404 may include a MAD 502 and accumulator 414. Although a single MAD 502 is shown being coupled to accumulator 414, each MAC 504 of a particular neural engine 314 may include multiple (e.g., 256) MADs that are coupled to accumulator 414. MAD 502 may include a first data path 504 and a second data path 505. Each of first data path 504 and second data path 504 may be configured to perform 8-bit floating point operations (also referred herein as “FP8” operations) concurrently in parallel, where 8-bit data values are provided as an input to each of first data path 504 and second data path 505. This advantageously doubles the throughput for FP8-related operations in a given processing cycle. In some embodiments, the 8-bit data values are in accordance with an E4M3 format, where such data values include a 1-bit sign value, a 4-bit exponent value, and a 3-bit mantissa value.

For a neural processor 218 including 16 neural engines 314 and each neural engine 314 including 256 MADs, the floating point operations may include 256 multiply-add operations in parallel for each neural engine 314 while processing a 256-byte work unit in a processing cycle across the 16 neural engines. Neural processor 218 may receive as input data 256 bytes which is treated as 256 8-bit floating point numbers. Neural processor 218 also receives two kernel coefficients, and multiplies the 256 floating point values by both kernel coefficients, producing two results. For a given MAC 404, each of first data path 504 and second data path 505 receives the same 8-bit floating point value. First data path 504 multiples the 8-bit floating point value by a first kernel coefficient, and second data path 505 multiples the 8-bit floating point value by a second kernel coefficient that may be different than or the same as the first kernel coefficient. Each of first data path 504 and second data path 505 may generate a different set of products and accumulates the partial results into different register files of accumulator 404. First data path 504 may accumulate its partial results into a first set of register files (e.g., even register files), and second data path 505 may accumulate its partial results into a second set of register files (e.g., odd register files). This advantageously prevents data collisions between first data path 504 and second data path 505, as each of first data path 504 and second data path 505 write to a different set of register files. Accordingly, in a given clock cycle, first data path 504 and second data path 505 collectively consume two kernel coefficients and produce two partial products. Additional details regarding first data path 504 and second data path 505 are provided below.

Each MAD 502 uses accumulator 414 for multi-processing cycle multiply-add operations within MAC 404. In some embodiments, accumulator 414 includes register files 414A-414H storing the output data of MADs as accumulated values from one or more processing cycles. Each of register files 414A-414H may include 32-bit entries. Values stored in each 32-bit entry of each of register files 414A-414H may be used as an accumulated value for an addition operation with output data generated by first data path 504 and/or second data path 505 for a subsequent (e.g., next) processing cycle. The values stored by accumulator 414 may be in accordance with a fixed point precision. That is, the values stored by accumulator 414 are fixed point values (rather than floating point values). As described above, the output data generated by first data path 504 may be stored in odd register files (e.g., register files 414A, 414C, 414E, and 414G) of accumulator 414, and the output data generated by second data path 505 may be stored in even register files (e.g., register files 414B, 414D, 414F, and 414H) of accumulator 414. Accumulator 414 may selectively provide the output data to MAD 502 as an accumulated value, or post-processor 428 when accumulation of multiplied values from multiple processing cycles is complete. In some embodiments, the fixed point values stored in accumulator 414 are converted back to floating point values (e.g., in an FP8 format) in post-processing.

As shown in FIG. 5, first data path 504 includes a multiplier 506, a shift register 508, an adder 510, an exponent adder 514, and a multiplexer (mux) 516. Multiplier 906 is coupled to shift register 508. Exponent adder 514 is coupled to shift offset register 512 and shift register 508. Shift register 508 is coupled to adder 510. Adder 510 is coupled to mux 516. Mux 516 is coupled to accumulator 414. Second data path 505 includes a multiplier 518, a shift register 520, an adder 522, an exponent adder 526, and a mux 528. Multiplier 918 is coupled to shift register 520. Exponent adder 526 is coupled to shift offset register 512 and shift register 520. Shift register 520 is coupled to adder 522. Adder 522 is coupled to mux 528. Mux 528 is coupled to accumulator 414. Shift offset register 512 may be a configuration register of neural processor 218.

Each of multiplier 506, shift register 508, adder 510, shift offset register 512, exponent adder 514, mux 516, multiplier 518, shift register 520, adder 522, exponent adder 526, and mux 528 may be implemented by processing logic that can include hardware (e.g., circuitry, dedicated logic, programmable logic, or microcode), software (e.g., instructions executing on a processing device), or a combination thereof.

Multiplier 506 is configured to receive a portion of the input data (e.g., a portion of an activation map) corresponding to the mantissa of the input data (e.g., the mantissa portion of the input data) from input buffer 402 and receive a portion of a kernel coefficient corresponding to the mantissa of the kernel coefficient (e.g., the mantissa portion of the kernel coefficient) from kernel extractor 432. Multiplier 506 may be configured to multiply the mantissa portion of the input data and the mantissa portion of the kernel coefficient to generate a multiplied value. In embodiments in which first data path 504 is configured to generate floating point numbers in accordance with an E4M3 format, the mantissa portion of the input data and the mantissa portion of the kernel coefficient are each 4 bits (3 bits for the mantissa plus 1 bit for the signed bit), and the multiplied value generated by multiplier 506 is 8 bits.

Exponent adder 514 may be configured to receive a portion of the input data corresponding to the exponent of the input data (e.g., the exponent portion of the input data) from input buffer 402, receive a portion of a kernel coefficient corresponding to the exponent of the kernel coefficient (e.g., the exponent portion of the kernel coefficient) from kernel extractor 432, and receive a binary point value indicative of a binary point position from shift offset register 512. Exponent adder 514 may be configured to add the exponent portion of the input data, the exponent portion of the kernel coefficient, and the binary point value to generate a shift factor value. In embodiments in which first data path 504 is configured to generate floating point numbers in accordance with an E4M3 format, the exponent portion of the input data and the exponent portion of the kernel coefficient are each 4 bits, and the shift factor value generated by exponent adder 514 is 4 bits.

Shift register 508 may be configured to shift the multiplied value provided by multiplier 506 based on the shift factor value provided by exponent adder 514 to generate a shifted value that is aligned with a fixed point precision of an accumulated value stored in one of register files 414A, 414C, 414E, and 414G. That is, shift register 504 generates the shifted value by realigning the multiplied value based on the shift factor. Accordingly, the shifted value is a fixed point value. In some embodiments, shift register 508 may use an arithmetic shift to align the binary point indicated by the binary point value provided by shift offset register 512. Shift register 508 may extend the bit size of the shifted value so that it corresponds to the bit size of accumulator 414. For instance, shift register 508 may sign extend the most significant bits of the shifted value, and the remaining bits may be padded with zeroes, thereby producing a fixed-point 32-bit shifted value.

Adder 510 may be configured to add the shifted value provided by shift register 508 with an accumulated value stored in one of register files 414A, 414C, 414E, and 414G to generate an output value. The register file from which the accumulated value is obtained may be determined by mux 516. For instance, a control signal may be provided to mux 516 that causes mux 516 to select a register file from register files 414A, 414C, 414E, and 414G from which the accumulated value is obtained. The accumulated value that is provided to the adder 510 via mux 516 may include a value stored by first data path 504 during one or more prior processing cycles. The output value generated by adder 510 may be stored in the same register file of register files 414A, 414C, 414E, and 414G from which the accumulated value was read. If there is no accumulated value to add with the shifted value, the shifted value is stored in one of register files 414A, 414C, 414E, and 414G.

Multiplier 518 is configured to receive a portion of the input data (e.g., the same portion of the activation map provided to multiplier 506) corresponding to the mantissa of the input data (e.g., the mantissa portion of the input data) from input buffer 402 and receive a portion of a kernel coefficient corresponding to the mantissa of the kernel coefficient (e.g., the mantissa portion of the kernel coefficient) from kernel extractor 432. Multiplier 518 may be configured to multiply the mantissa portion of the input data and the mantissa portion of the kernel coefficient to generate a multiplied value. In embodiments in which second data path 505 is configured to generate floating point numbers in accordance with an E4M3 format, the mantissa portion of the input data and the mantissa portion of the kernel coefficient are each 4 bits (3 bits for the mantissa plus 1 bit for the signed bit), and the floating point value generated by multiplier 518 is 8 bits.

Exponent adder 526 may be configured to receive a portion of the input data corresponding to the exponent of the input data (e.g., the exponent portion of the input data) from input buffer 402, receive a portion of a kernel coefficient corresponding to the exponent of the kernel coefficient (e.g., the exponent portion of the kernel coefficient) from kernel extractor 432, and receive the binary point value indicative of a binary point position from shift offset register 512. Exponent adder 526 may be configured to add the exponent portion of the input data, the exponent portion of the kernel coefficient, and the binary point value to generate a shift factor value. In embodiments in which second data path 505 is configured to generate floating point numbers in accordance with an E4M3 format, the exponent portion of the input data and the exponent portion of the kernel coefficient are each 4 bits, and the shift factor value generated by exponent adder 514 is 4 bits. It is noted that, in some embodiments, different binary point values may be utilized for each of first data path 504 and second data path 505.

Shift register 520 may be configured to shift the multiplied value provided by multiplier 518 based on the shift factor value provided by exponent adder 526 to generate a shifted value that is aligned with a fixed point precision of an accumulated value stored in one of register files 414B, 414D, 414F, and 414H. That is, shift register 520 generates the shifted value by realigning the floating point value based on the shift factor. Accordingly, the shifted value is a fixed point value. In some embodiments, shift register 520 may use an arithmetic shift to align the binary point indicated by the binary point value provided by shift offset register 512. Shift register 520 may extend the bit size of the shifted value so that it corresponds to the bit size of accumulator 414. For instance, shift register 520 may sign extend the most significant bits of the shifted value, and the remaining bits may be padded with zeroes, thereby producing a fixed-point 32-bit shifted value.

Adder 522 may be configured to add the shifted value provided by shift register 520 with an accumulated value stored in one of register files 414B, 414D, 414F, and 414H to generate an output value. The register file from which the accumulated value is obtained may be determined by mux 528. For instance, a control signal may be provided to mux 528 that causes mux 528 to select a register file from register files 414B, 414D, 414F, and 414H from which the accumulated value is obtained. The accumulated value that is provided to the adder 522 via mux 528 may include a value stored by second data path 505 during one or more prior processing cycles. The output value generated by adder 522 may be stored in the same register file of register files 414B, 414D, 414F, and 414H from which the accumulated value was read. If there is no accumulated value to add with the shifted value, the shifted value is stored in one of register files 414B, 414D, 414F, and 414H.

In some embodiments, first data path 504 is configurable to perform 16-bit floating point operations (FP16). In some embodiments, MAC 404 is configurable to operate in different modes. A first mode may be a 2× FP8 mode, where each of first data path 504 and second data path 505 concurrently perform FP8 operations on the same input data, but utilizing different kernel coefficients, as described above. A second mode may be an FP16 mode, where second data path 505 is disabled (e.g., via clock gating), and just first data path 504 is utilized to perform FP16 operations. To support FP16 operations, first data path 504 supports a larger bit width, for example, than second data path 505. For instance, first multiplier 506 may be configured to receive and operate on 11-bit values (e.g., a 10-bit mantissa value and a 1-bit signed bit), exponent adder 514 may be configured to receive and operate on 5-bit values (e.g., a 5-bit exponent value), and shift register 508 may also be configured to receive and operate on 22-bit values. Moreover, adder 510 may be configured to add accumulated data from and write output data to any of register files 414A-414H. Accordingly, mux 516 may be reconfigured to selectively obtain data from any of register files 414A-414H. When the first mode is activated, the same multiplier 506, exponent adder 514, and shift register 508 are utilized as in the second mode, but values having narrower bit widths are provided thereto. For example, as described above, multiplier 506 is provided a 4-bit value (a 3-bit mantissa value and a 1-bit signed bit), exponent adder 514 is provided a 4-bit value (e.g., a 4-bit exponent value), and shift register 508 is provided an 8-bit value (e.g., an 8-bit floating point value provided by multiplier 506). A third mode may be a 2× INT8 mode, where each of first data path 504 and second data path 505 is utilized to perform INT8 operations. To support INT8 operations, first data path 504 and second data path 505 support a larger bit width. For instance, first multiplier 506 and second multiplier 518 may be configured to receive and operate on 9-bit values (which accommodates any combination of unsigned or signed 8-bit values). Exponent adder 514, exponent adder 526, shift register 508, and shift register 520 may be deactivated. When the first mode is activated, the same multiplier 506 and multiplier 518 are utilized as in the second mode, but values having narrower bit widths are provided thereto. For example, as described above, multiplier 506 is provided a 4-bit value (a 3-bit mantissa value and a 1-bit signed bit), exponent adder 514 is provided a 4-bit value (e.g., a 4-bit exponent value), and shift register 508 is provided an 8-bit value (e.g., an 8-bit floating point value provided by multiplier 506).

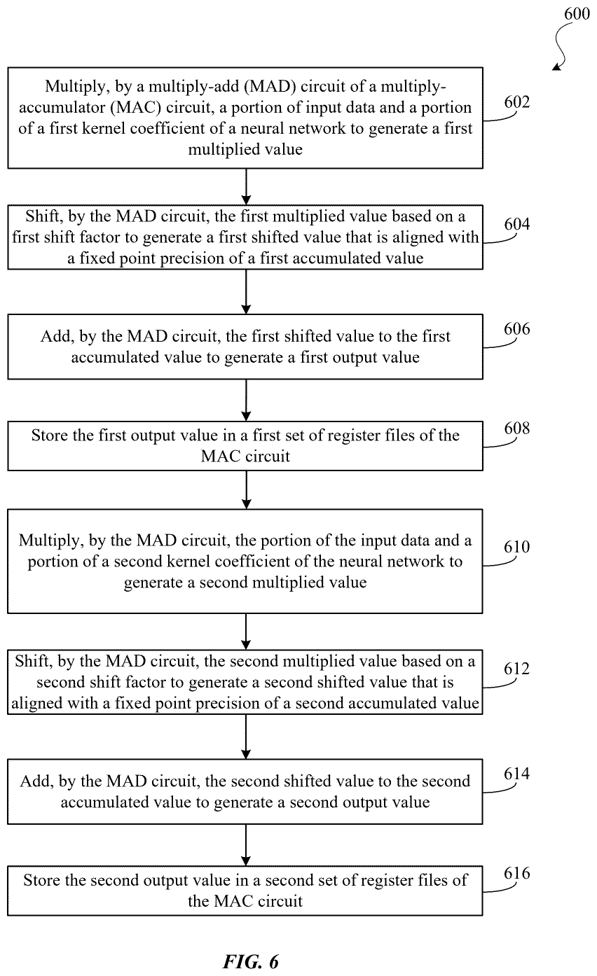

FIG. 6 is a flowchart for a method 600 for performing floating point operations, according to some embodiments. Method 600 can be performed by processing logic that can include hardware (e.g., circuitry, dedicated logic, programmable logic, or microcode), software (e.g., instructions executing on a processing device), or a combination thereof. It is to be appreciated that not all steps may be needed to perform the disclosure provided herein. Further, some of the steps may be performed simultaneously, or in a different order than shown in FIG. 6, as will be understood by a person of ordinary skill in the art.

Method 600 shall be described with reference to FIGS. 4-5. Method 600 is not limited to those example embodiments.

In 602, a MAD circuit (e.g., MAD 502) of a MAC circuit (MAC 404) may multiply a portion of input data and a portion of a first kernel coefficient of a neural network to generate a first multiplied value. For example, as shown in FIG. 5, multiplier 506 of MAD 502 may be configured to multiply a portion of input data (e.g., received from input buffer 402) and a portion of a first kernel coefficient (e.g., received from kernel extractor 432) of a neural network to generate a first multiplied value. In some embodiments, the portion of the input data corresponds to a mantissa value of the input data, and the portion of the first kernel coefficient corresponds to a mantissa value of the first kernel coefficient.

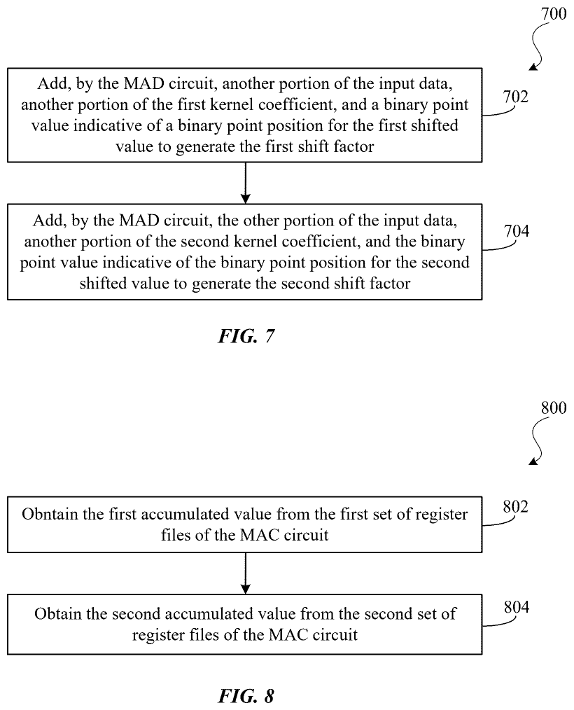

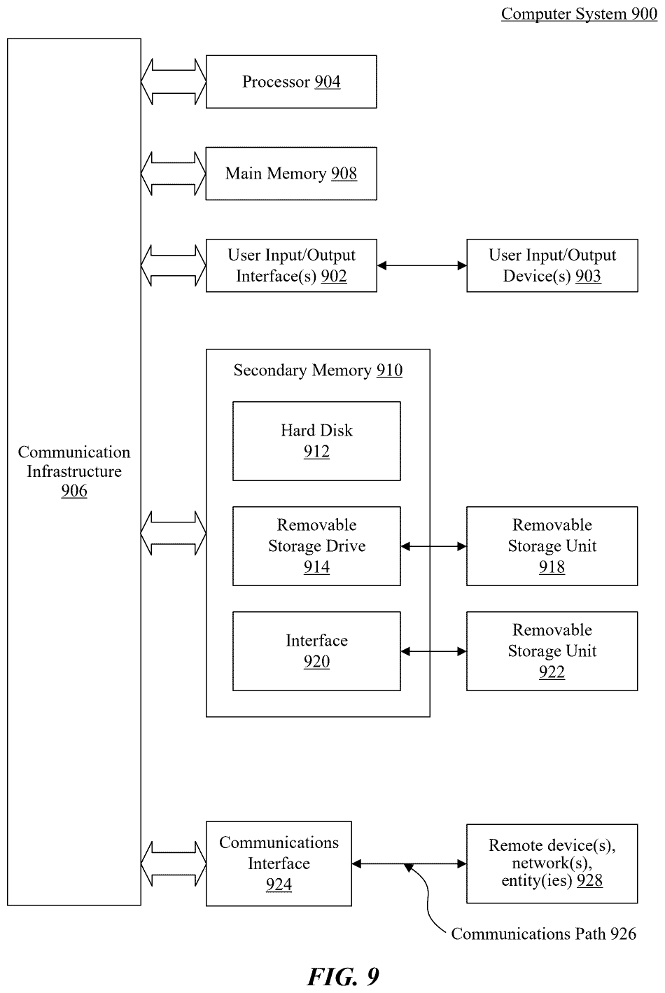

In 604, the MAD circuit (e.g., MAD 502) may shift the first multiplied value based on a first shift factor to generate a first shifted value that is aligned with a fixed point precision of a first accumulated value. For example, as shown in FIG. 5, shift register 508 of MAD 502 may shift the first multiplied value provided by multiplier 506 based on a first shift factor to generate a first shifted value that is aligned with a fixed point precision of a first accumulated value (e.g., stored in one of register files 414A, 414C, 414E, or 414G). In some embodiments, MAD 502 may generate the first accumulated value during a first processing cycle of the MAC circuit (e.g., MAC 404), and MAD 502 may shift the first multiplied value by generating the first shifted value during a second processing cycle of the MAC circuit that occurs after the first processing cycle. Additional details regarding the first shift factor and the first accumulated value are provided below with reference to FIG. 7 and FIG. 9, respectively.

In 606, the MAD circuit (e.g., MAD 502) may add the first shifted value to the first accumulated value to generate a first output value. For example, as shown in FIG. 5, adder 508 of MAD 502 may add the first shifted value provided by shift register 508 to the first accumulated value to generate a first output value.

In 608, the MAD circuit (e.g., MAD 502) may store the first output value in a first set of register files of the MAC circuit. For example, referring to FIG. 5, the first output value generated by adder 510 is stored in a first set of register files of accumulator 414 (e.g., one of register files 414A, 414C, 414E, or 414G).

In 610, the MAD circuit (e.g., MAD 502) may multiply the portion of input data and a portion of a second kernel coefficient of the neural network to generate a second multiplied value. For example, as shown in FIG. 5, multiplier 518 of MAD 502 may be configured to multiply the portion of input data (e.g., received from input buffer 402) and a portion of a second kernel coefficient (e.g., received from kernel extractor 432) of the neural network to generate a second multiplied value. In some embodiments, the portion of the second kernel coefficient corresponds to a mantissa value of the second kernel coefficient.

In 612, the MAD circuit (e.g., MAD 502) may shift the second multiplied value based on a second shift factor to generate a second shifted value that is aligned with a fixed point precision of a second accumulated value. For example, as shown in FIG. 5, shift register 520 of MAD 502 may shift the second multiplied value provided by multiplier 518 based on a second shift factor to generate a second shifted value that is aligned with a fixed point precision of a second accumulated value (e.g., stored in one of register files 414B, 414D, 414F, or 414H). In some embodiments, MAD 502 may generate the second accumulated value during a first processing cycle of the MAC circuit (e.g., MAC 404), and MAD 502 may shift the second multiplied value by generating the second shifted value during a second processing cycle of the MAC circuit that occurs after the first processing cycle. Additional details regarding the second shift factor and the second accumulated value are provided below with reference to FIG. 7 and FIG. 9, respectively.

In 614, the MAD circuit (e.g., MAD 502) may add the second shifted value to the second accumulated value to generate a second output value. For example, as shown in FIG. 5, adder 522 of MAD 502 may add the second shifted value provided by shift register 520 to the second accumulated value to generate a second output value.

In 616, the MAD circuit (e.g., MAD 502) may store the second output value in a second set of register files of the MAC circuit. For example, referring to FIG. 5, the second output value generated by adder 522 is stored in a second set of register files of accumulator 414 (e.g., one of register files 414B, 414D, 414F, or 414H). In some embodiments, the first set of register files are different from the second set of register files.

FIG. 7 is a flowchart for a method 700 for generating a first shift factor and a second shift factor, according to some embodiments. Method 700 can be performed by processing logic that can include hardware (e.g., circuitry, dedicated logic, programmable logic, or microcode), software (e.g., instructions executing on a processing device), or a combination thereof. It is to be appreciated that not all steps may be needed to perform the disclosure provided herein. Further, some of the steps may be performed simultaneously, or in a different order than shown in FIG. 7, as will be understood by a person of ordinary skill in the art.

Method 700 shall be described with reference to FIG. 5. Method 700 is not limited to that example embodiment.

In 702, the MAD circuit (e.g., MAD 502) may add another portion of the input data, another portion of the first kernel coefficient, and a binary point value indicative of a binary point position for the first shifted value to generate the first shift factor. For example, as shown in FIG. 5, exponent adder 514 may add another portion of the input data, another portion of the first kernel coefficient, and a binary point value indicative of a binary point position for the first shifted value to generate the first shift factor. In some embodiments, the other portion of the input data corresponds to an exponent value of the input data, and the other portion of the first kernel coefficient corresponds to an exponent value of the first kernel coefficient.

In 704, the MAD circuit (e.g., MAD 502) may add another portion of the input data, another portion of the second kernel coefficient, and the binary point value indicative of the binary point position for the second shifted value to generate the second shift factor. For example, as shown in FIG. 5, exponent adder 526 may add another portion of the input data, another portion of the second kernel coefficient, and the binary point value indicative of the binary point position for the second shifted value to generate the second shift factor. In some embodiments, the other portion of the second kernel coefficient corresponds to an exponent value of the second kernel coefficient. In some embodiments, the binary point value utilized by exponent adder 514 and exponent adder 526 is obtained from a configuration register (e.g., shift offset register 512).

FIG. 8 is a flowchart for a method 800 for obtaining a first accumulated value and a second accumulated value, according to some embodiments. Method 800 can be performed by processing logic that can include hardware (e.g., circuitry, dedicated logic, programmable logic, or microcode), software (e.g., instructions executing on a processing device), or a combination thereof. It is to be appreciated that not all steps may be needed to perform the disclosure provided herein. Further, some of the steps may be performed simultaneously, or in a different order than shown in FIG. 8, as will be understood by a person of ordinary skill in the art.

Method 800 shall be described with reference to FIG. 5. Method 800 is not limited to that example embodiment.

In 802, the MAD circuit (e.g., MAD 502) may obtaining the first accumulated value from the first set of register files of the MAC circuit. For example, as shown in FIG. 5, mux 516 may obtain the first accumulated value from one of register files 414A, 414C, 414E, or 414G and provide the first accumulated value to adder 510.

In 804, the MAD circuit (e.g., MAD 502) may obtaining the second accumulated value from the second set of register files of the MAC circuit. For example, as shown in FIG. 5, mux 528 may obtain the second accumulated value from one of register files 414B, 414D, 414F, or 414H and provide the second accumulated value to adder 520.

Various aspects can be implemented, for example, using one or more computer systems, such as computer system 900 shown in FIG. 9. Computer system 900 can be any computer capable of performing the functions described herein, such as the functions of device 100 of FIGS. 1 and 2 (and the components thereof), neural processor 218 of FIG. 2 (and the components thereof), neural engine 314 of FIG. 3 (and the components thereof), MAD 502 (and the components thereof), and the operations of FIGS. 6-8. Computer system 900 includes one or more processors (also called central processing units, or CPUs), such as a processor 904. Processor 904 is connected to a communication infrastructure 906 (e.g., a bus). Computer system 900 also includes user input/output device(s) 903, such as monitors, keyboards, pointing devices, etc., that communicate with communication infrastructure 906 through user input/output interface(s) 902. Computer system 900 also includes a main or primary memory 908, such as random access memory (RAM). Main memory 908 may include one or more levels of cache. Main memory 908 has stored therein control logic (e.g., computer software) and/or data.

Computer system 900 may also include one or more secondary storage devices or memory 910. Secondary memory 910 may include, for example, a hard disk drive 912 and/or a removable storage device or drive 914. Removable storage drive 914 may be a floppy disk drive, a magnetic tape drive, a compact disk drive, an optical storage device, tape backup device, and/or any other storage device/drive.

Removable storage drive 914 may interact with a removable storage unit 918. Removable storage unit 918 includes a computer usable or readable storage device having stored thereon computer software (control logic) and/or data. Removable storage unit 918 may be a floppy disk, magnetic tape, compact disk, DVD, optical storage disk, and/or any other computer data storage device. Removable storage drive 914 reads from and/or writes to removable storage unit 918 in a well-known manner.

According to some aspects, secondary memory 910 may include other means, instrumentalities or other approaches for allowing computer programs and/or other instructions and/or data to be accessed by computer system 900. Such means, instrumentalities or other approaches may include, for example, a removable storage unit 922 and an interface 920. Examples of the removable storage unit 922 and the interface 920 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 900 may further include a communication or network interface 924. Communication interface 924 enables computer system 900 to communicate and interact with any combination of remote devices, remote networks, remote entities, etc. (individually and collectively referenced by reference number 928). For example, communication interface 924 may allow computer system 900 to communicate with remote devices 928 over communications path 926, which may be wired and/or wireless, and which may include any combination of LANs, WANs, the Internet, etc. Control logic and/or data may be transmitted to and from computer system 900 via communication path 926.

The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 900, main memory 908, secondary memory 910 and removable storage units 918 and 922, as well as tangible articles of manufacture embodying any combination of the foregoing. Such control logic, when executed by one or more data processing devices (such as computer system 900), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 9. In particular, aspects may operate with software, hardware, and/or operating system implementations other than those described herein.

It is to be appreciated that the Detailed Description section, and not the Abstract of the Disclosure section, is intended to be used to interpret the claims. The Abstract of the Disclosure section may set forth one or more but not all possible aspects of the present disclosure as contemplated by the inventor(s), and thus, are not intended to limit the subjoined claims in any way.

Unless stated otherwise, the specific aspects are not intended to limit the scope of claims that are drafted based on this disclosure to the disclosed forms, even where only a single example is described with respect to a particular feature. The disclosed aspects are thus intended to be illustrative rather than restrictive, absent any statements to the contrary. The application is intended to cover such alternatives, modifications, and equivalents that would be apparent to a person skilled in the art having the benefit of this disclosure.

The foregoing disclosure outlines features of several aspects so that those skilled in the art may better understand the aspects of the present disclosure. Those skilled in the art will appreciate that they may readily use the present disclosure as a basis for designing or modifying other processes and structures for carrying out the same purposes and/or achieving the same advantages of the aspects introduced herein. Those skilled in the art will also realize that such equivalent constructions do not depart from the spirit and scope of the present disclosure, and that they may make various changes, substitutions, and alterations herein without departing from the spirit and scope of the present disclosure.

What is claimed is:

1. A system, comprising:
a neural engine circuit configured to execute a neural network, comprising:
a first multiplier circuit configured to multiply a portion of input data and a portion of a first kernel coefficient of the neural network to generate a first multiplied value;
a first shift register circuit configured to shift the first multiplied value based on a first shift factor to generate a first shifted value that is aligned with a fixed point precision of a first accumulated value;
a first adder circuit configured to add the first shifted value to the first accumulated value to generate a first output value;
a first set of register files configured to store the first output value;
a second multiplier circuit configured to multiply the portion of the input data and a portion of a second kernel coefficient of the neural network to generate a second multiplied value;
a second shift register circuit configured to shift the second multiplied value based on a second shift factor to generate a second shifted value that is aligned with a fixed point precision of a second accumulated value;
a second adder circuit configured to add the second shifted value to the second accumulated value to generate a second output value; and
a second set of register files configured to store the second output value.

2. The system of claim 1, further comprising:
a first exponent adder circuit configured to add another portion of the input data, another portion of the first kernel coefficient, and a binary point value indicative of a binary point position for the first shifted value to generate the first shift factor; and
a second exponent adder circuit configured to add the other portion of the input data, another portion of the second kernel coefficient, and the binary point value indicative of the binary point position for the second shifted value to generate the second shift factor.

3. The system of claim 2, wherein the portion of the input data corresponds to a mantissa value of the input data, the portion of the first kernel coefficient corresponds to a mantissa value of the first kernel coefficient, the other portion of the input data corresponds to an exponent value of the input data, the other portion of the first kernel coefficient corresponds to an exponent value of the first kernel coefficient, the portion of the second kernel coefficient corresponds to a mantissa value of the second kernel coefficient, and the other portion of the second kernel coefficient corresponds to an exponent value of the second kernel coefficient.

4. The system of claim 2, further comprising:
a configuration register configured to store the binary point value.

5. The system of claim 1, further comprising:
a first multiplexer circuit configured to obtain the first accumulated value from the first set of register files of the MAC circuit; and
a second multiplexer circuit configured to obtain the second accumulated value from the second set of register files of the MAC circuit.

6. The system of claim 1, wherein the first accumulated value and the second accumulated value are generated during a first processing cycle of the neural engine circuit, and wherein the first multiplied value and the second multiplied value are generated during a second processing cycle of the neural engine circuit that occurs after the first processing cycle.

7. The system of claim 1, wherein the first multiplier circuit and the first shift register support a greater bit width of data than the second multiplier circuit and the second shift register.

8. A method, comprising:
multiplying, by a multiply-add (MAD) circuit of a multiply-accumulate (MAC) circuit, a portion of input data and a portion of a first kernel coefficient of a neural network to generate a first multiplied value;
shifting, by the MAD circuit, the first multiplied value based on a first shift factor to generate a first shifted value that is aligned with a fixed point precision of a first accumulated value;
adding, by the MAD circuit, the first shifted value to the first accumulated value to generate a first output value;
storing the first output value in a first set of register files of the MAC circuit;
multiplying, by MAD circuit, the portion of the input data and a portion of a second kernel coefficient of the neural network to generate a second multiplied value;
shifting, by the MAD circuit, the second multiplied value based on a second shift factor to generate a second shifted value that is aligned with a fixed point precision of a second accumulated value;
adding, by the MAD circuit, the second shifted value to the second accumulated value to generate a second output value; and
storing the second output value in a second set of register files of the MAC circuit.

9. The method of claim 8, further comprising:
adding, by the MAD circuit, another portion of the input data, another portion of the first kernel coefficient, and a binary point value indicative of a binary point position for the first shifted value to generate the first shift factor; and
adding, by the MAD circuit, the other portion of the input data, another portion of the second kernel coefficient, and the binary point value indicative of the binary point position for the second shifted value to generate the second shift factor.

10. The method of claim 9, wherein the portion of the input data corresponds to a mantissa value of the input data, the portion of the first kernel coefficient corresponds to a mantissa value of the first kernel coefficient, the other portion of the input data corresponds to an exponent value of the input data, the other portion of the first kernel coefficient corresponds to an exponent value of the first kernel coefficient, the portion of the second kernel coefficient corresponds to a mantissa value of the second kernel coefficient, and the other portion of the second kernel coefficient corresponds to an exponent value of the second kernel coefficient.

11. The method of claim 9, further comprising:
obtaining the binary point value from a configuration register.

12. The method of claim 8, further comprising:
obtaining the first accumulated value from the first set of register files of the MAC circuit; and
obtaining the second accumulated value from the second set of register files of the MAC circuit.

13. The method of claim 8, wherein the first accumulated value and the second accumulated value are generated during a first processing cycle of the MAC circuit, and wherein shifting the first and second multiplied values comprises generating the first and second shifted values during a second processing cycle of the MAC circuit and that occurs after the first processing cycle.

14. The method of claim 8, wherein the first set of register files is different from the second set of register files.

15. A non-transitory computer readable medium having instructions stored thereon that, when executed by at least one processor, cause the at least one processor to perform operations comprising:
multiplying, by a multiply-add (MAD) circuit of a multiply-accumulate (MAC) circuit, a portion of input data and a portion of a first kernel coefficient of a neural network to generate a first multiplied value;
shifting, by the MAD circuit, the first multiplied value based on a first shift factor to generate a first shifted value that is aligned with a fixed point precision of a first accumulated value;
adding, by the MAD circuit, the first shifted value to the first accumulated value to generate a first output value;
storing the first output value in one register file of a first set of register files of the MAC circuit;
multiplying, by the MAD circuit, the portion of the input data and a portion of a second kernel coefficient of the neural network to generate a second multiplied value;
shifting, by the MAD circuit, the second multiplied value based on a second shift factor to generate a second shifted value that is aligned with a fixed point precision of a second accumulated value;
adding, by the MAD circuit, the second shifted value to the second accumulated value to generate a second output value; and
storing the second output value in one register file of a second set of register files of the MAC circuit that is different than the first set of register files.

16. The non-transitory computer readable medium of claim 15, the operations further comprising:
adding, by the MAD circuit, another portion of the input data, another portion of the first kernel coefficient, and a binary point value indicative of a binary point position for the first shifted value to generate the first shift factor; and
adding, by the MAD circuit, the other portion of the input data, another portion of the second kernel coefficient, and the binary point value indicative of the binary point position for the second shifted value to generate the second shift factor.

17. The non-transitory computer readable medium of claim 16, wherein the portion of the input data corresponds to a mantissa value of the input data, the portion of the first kernel coefficient corresponds to a mantissa value of the first kernel coefficient, the other portion of the input data corresponds to an exponent value of the input data, the other portion of the first kernel coefficient corresponds to an exponent value of the first kernel coefficient, the portion of the second kernel coefficient corresponds to a mantissa value of the second kernel coefficient, and the other portion of the second kernel coefficient corresponds to an exponent value of the second kernel coefficient.

18. The non-transitory computer readable medium of claim 16, the operations further comprising:
obtaining the binary point value from a configuration register.

19. The non-transitory computer readable medium of claim 15, the operations further comprising:
obtaining the first accumulated value from the first set of register files of the MAC circuit; and
obtaining the second accumulated value from the second set of register files of the MAC circuit.

20. The non-transitory computer readable medium of claim 15, wherein the first accumulated value and the second accumulated value are generated during a first processing cycle of the MAC circuit, and wherein shifting the first and second floating point values comprises generating the first and second shifted values during a second processing cycle of the MAC circuit and that occurs after the first processing cycle.
